(19) United States
(12) Patent Application Publication
(10) Pub. No.: US 2008/0192303 A1
(43) Pub. Date: Aug. 14, 2008

(54) METHOD AND APPARATUS FOR GENERATING SYNCHRONIZATION SIGNAL AND IMAGE DISPLAY DEVICE

(75) Inventor: Seung-choul SONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/850,954

(22) Filed: Sep. 6, 2007

(30) Foreign Application Priority Data
Feb. 8, 2007 (KR) 10-2007-0013311

(51) Int. Cl. H04N 1/36

(52) U.S. Cl. 358/409

(57) ABSTRACT

Provided are a method and apparatus for generating a synchronization signal. The method includes generating a square wave signal based on a sensing signal, which shows a motion of a scanner, and a specified threshold signal, generating a reference signal having a phase locked reference frequency, based on the generated square wave signal, and generating a synchronization signal synchronized with the motion of the scanner, based on the generated reference signal. By outputting an image signal according to the generated synchronization signal, the motion of the scanner and the image signal can be synchronized.

### CROSS-REFERENCE TO RELATED PATENT APPLICATION

This application claims priority from Korean Patent Application No. 10-2007-0013311, filed on Feb. 8, 2007, in the Korean Intellectual Property Office, the disclosure of which is incorporated herein in its entirety by reference.

### BACKGROUND OF THE INVENTION

1. Field of the Invention

The present invention relates to a laser scanning image display device, and more particularly, to an apparatus for generating a synchronization signal used in an apparatus for processing an image signal of an image that is displayed.

2. Description of the Related Art

Conventional projection display devices having a lamp as a light source are known to express approximately 30% of all colors that a human being can visually recognize. Accordingly, developers of display devices try to improve the color expressing capacity of display devices. Such efforts include using a laser as a light source. A laser is a single-color light, thus laser display devices have 3 times better color expressing capacity than conventional display devices using a phosphor lamp as a light source.

FIG. 1 is a diagram illustrating a conventional image display device having a laser as a light source.

Referring to FIG. 1, a laser diode driver 100 generates a driving signal for driving a laser diode 110 according to a received image signal, and transmits the driving signal to the laser diode 110.

The laser diode 110 is formed of a laser diode R 110a, a laser diode G 110b, and a laser diode B 110c. The laser diode R 110a, laser diode G 110, and laser diode B 110c emit light according to the driving signal transmitted from the laser diode driver 100, and transmit the light to a scanner 120.

The scanner 120 reflects the light transmitted from the laser diode 110 onto a projection plane 140 in order to express a laser image.

Meanwhile, a scanner driver 130 regulates a reflection angle of the scanner 120.

However in the image display devices having such a laser as a light source, motions of the received image signal and the scanner 120 are not identical, and thus the received image signal cannot be accurately displayed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Non-limiting exemplary embodiments of the present invention provide a method and apparatus for generating a reference signal having a reference frequency from a sensing signal of a scanner and generating a synchronization signal synchronized with the motion of the scanner based on the reference signal.

Non-limiting exemplary embodiments of the present invention also provide a computer readable recording medium having recorded thereon a program for executing a method of generating a reference signal having a reference frequency from a sensing signal of a scanner and generating a synchronization signal synchronized with the motion of the scanner based on the reference signal.

According to an aspect of the present invention, there is provided a method of generating a synchronization signal, including: generating a square wave signal based on a sensing signal, which shows a motion of a scanner, and a predetermined threshold signal; generating a reference signal having a phase locked reference frequency, based on the generated square wave signal; and generating a synchronization signal synchronized with the motion of the scanner, based on the generated reference signal.

According to another aspect of the present invention, there is provided a computer readable recording medium having recorded thereon a program for executing the method described above.

According to another aspect of the present invention, there is provided an apparatus for generating a synchronization signal, including: a comparator which generates a square wave signal based on a sensing signal, which shows a motion of a scanner, and a predetermined threshold signal; a phase locked loop which generates a reference signal having a phase locked reference frequency, based on the generated square wave signal; and a synchronization signal generator which generates a synchronization signal synchronized with the motion of the scanner, based on the generated reference signal.

According to another aspect of the present invention, there is provided an image display device including: a scanner driver which generates a driving signal of a scanner; a sensor which generates a sensing signal by detecting a motion of the scanner which moves according to the generated driving signal; an apparatus for generating a synchronization signal which generates a synchronization signal synchronized with the motion of the scanner, based on the generated sensing signal; a light emitter which emits a light based on the generated synchronization signal and a received image signal; and the scanner which displays an image by reflecting the emitted light.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional image display device having a laser as a light source;

FIG. 2 is a diagram illustrating an apparatus for generating a synchronization signal according to an exemplary embodiment of the present invention;

FIGS. 3A through 3C are diagrams for describing operations of a scanner;

FIG. 4 is a timing diagram illustrating signals output from elements of an apparatus for generating a synchronization signal according to an exemplary embodiment of the present invention;

FIG. 5 is a flowchart of a method of generating a synchronization signal according to an exemplary embodiment of the present invention; and

FIG. 6 is a block diagram of an image display device including an apparatus for generating a synchronization signal according to an exemplary embodiment of the present invention.

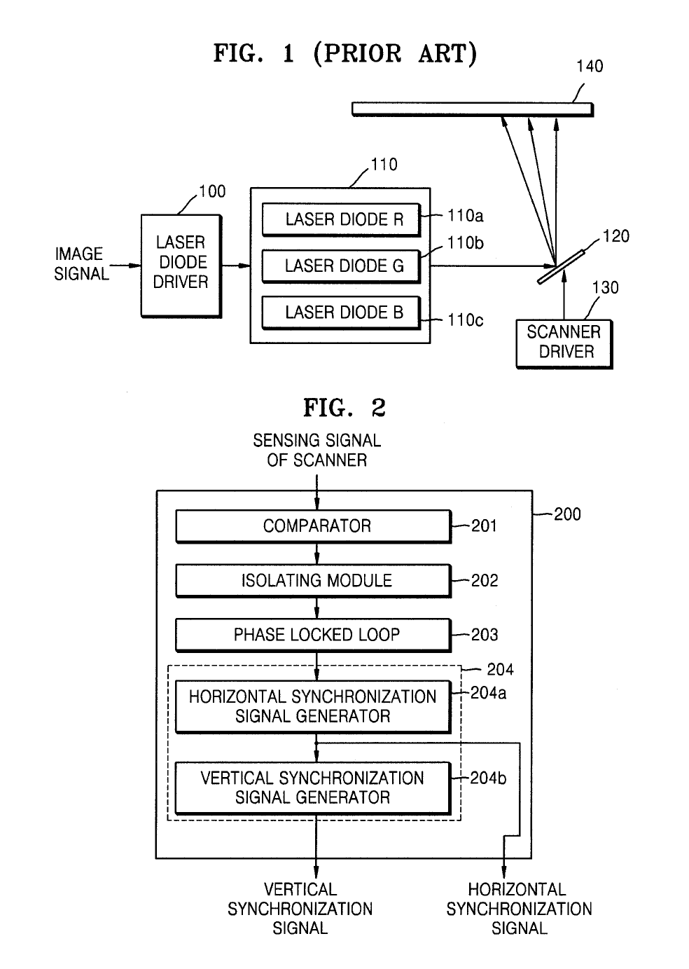

### DETAILED DESCRIPTION OF THE EXEMPLARY EMBODIMENTS

Hereinafter, the present invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, like reference numerals denote like elements. Also, while describing the present invention, detailed descriptions about related well-known functions or configurations that may diminish the clarity of the points of the present invention are omitted.

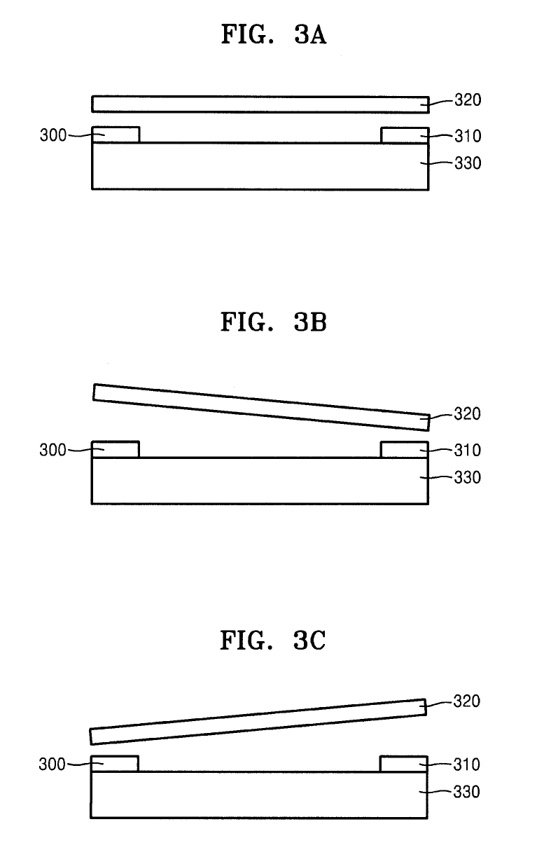

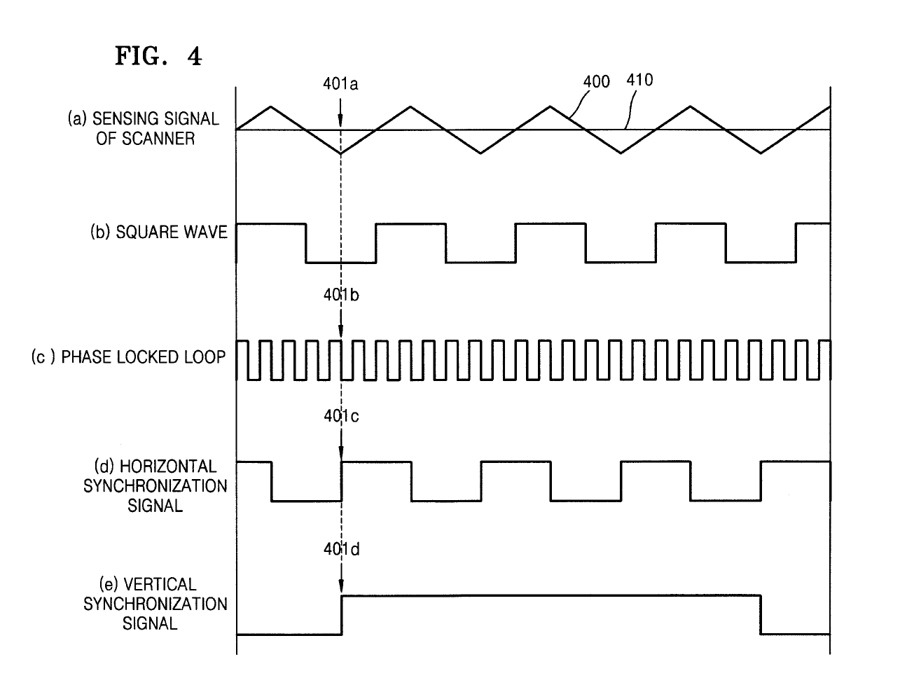

FIG. 2 is a diagram illustrating an apparatus 200 for generating a synchronization signal according to an exemplary embodiment of the present invention. The apparatus 200 includes a comparator 201, an isolating module 202, a phase locked loop 203, and a synchronization signal generator 204. The synchronization signal generator 204 includes a horizontal synchronization signal generator 204a and a vertical synchronization signal generator 204b. FIGS. 3A through 3C are diagrams for describing operations of a scanner, and FIG. 4 is a timing diagram illustrating signals output from elements of the apparatus 200 illustrated in FIG. 2. The apparatus 200 will now be described in reference to FIGS. 2, 3A, 3B, 3C, and 4.

Referring to FIG. 2, the comparator 201 generates a square wave signal from a sensing signal of the scanner and a specified threshold signal, and transmits the generated square wave signal to the isolating module 202.

First, the operations of the scanner will be described in detail with reference to FIGS. 3A through 3C.

Referring to FIG. 3A, the scanner is formed of a first electrode 300, a second electrode 310, a third electrode 320, and a substrate 330. The first electrode 300 and the second electrode 310 have opposite polarities, and a bias voltage having a uniform magnitude is applied to the first and second electrodes 300 and 310. Then, when a voltage is applied to the third electrode 320, the third electrode 320 inclines to one side due to a voltage difference between the third electrode 320 and the first electrode 300, and due to a voltage difference between the third electrode 320 and the second electrode 310.

For example, in FIG. 3B, when a 100V bias voltage is applied to the first electrode 300 and a −100V bias voltage is applied to the second electrode 310, and then 10V is applied to the third electrode 320, a voltage difference of 90V is formed between the first and third electrodes 300 and 320, and a voltage difference of 110V is formed between the second and third electrodes 310 and 320. Accordingly, the third electrode 320 inclines to one side as shown in FIG. 3B.

Alternatively, in FIG. 3C, when a 100V bias voltage is applied to the first electrode 300 and a −100V bias voltage is applied to the second electrode 310, and then −10V is applied to the third electrode 320, a voltage difference of 110V is formed between the first and third electrodes 300 and 320 and a voltage difference of 90V is formed between the second and third electrodes 310 and 320. Accordingly, the third electrode 320 inclines to one side as shown in FIG. 3C.

FIG. 4 (a) illustrates a sensing signal 400 of the scanner and a specified threshold signal 410. Referring to FIG. 4 (a), the sensing signal 400 is a triangular waveform. The third electrode 320 inclines to one side as illustrated in FIG. 3B during the increasing part of the triangular waveform and as illustrated in FIG. 3C during the decreasing part of the triangular waveform. FIG. 4 (b) illustrates the square wave signal output from the comparator 201 illustrated in FIG. 2 based on a comparison of the sensing signal 400 and the specified threshold signal 410.

The isolating module 202 illustrated in FIG. 2 isolates the square wave signal received from the comparator 201 from a previous stage and transmits the isolated square wave signal to the phase locked loop 203. A device which uses light as a medium, for example, but not limited to, a photo coupler, may be used as the isolating module 202. By using the isolating module 202, noise flowing into the apparatus 200 can be decreased.

The phase locked loop 203 generates a reference signal having a phase locked reference frequency from the square wave signal received from the isolating module 202, and transmits the generated reference signal to the synchronization signal generator 204. The reference frequency of the reference signal generated by the phase locked loop 203 is about 74.25 MHz. The phase locked loop 203 is a circuit which obtains a stabilized output of a frequency equal to (divided or multiplied by) a frequency of a reference signal by using a negative feedback circuit. The phase locked loop 203 is used for two reasons. First, so as not to swing a signal source input to the apparatus 200, that is, not to swing a signal source by uniformly fixing the phase of the sensing signal 400 of the scanner. Second, the phase locked loop 203 is used to change the frequency of the signal source input to the phase locked loop 203. The frequency of the changed signal source output from the phase locked loop 203 is used as a reference frequency for generating a synchronization signal as will be described below.

FIG. 4 (c) illustrates the reference signal, which is an output of the phase locked loop 203. As described above, the frequency of the reference signal is about 74.25 MHz.

The synchronization signal generator 204 generates a synchronization signal synchronized with the motion of the scanner, based on the generated reference signal. The horizontal synchronization signal generator 204a of the synchronization signal generator 204 generates a horizontal synchronization signal of a first frequency by frequency dividing the reference frequency of the reference signal generated from the phase locked loop 203, and transmits the generated horizontal synchronization signal to the vertical synchronization signal generator 240b.

Then, the vertical synchronization signal generator 204b of the synchronization signal generator 204 generates a vertical synchronization signal of a second frequency by frequency dividing the first frequency of the horizontal synchronization signal received from the horizontal synchronization signal generator 204a. Here, the first frequency is about 45 KHz and the second frequency is about 60 Hz. Unlike a frequency of a horizontal synchronization signal specified by the National Television System Committee according to the image standard, the frequency of the horizontal synchronization signal according to the current exemplary embodiment is about 45 KHz, which is twice the frequency of the horizontal synchronization signal according to the image standard. This is because, generally, an image signal is output only when a scan is performed from left to right (forward direction), and not outputted when a scan is performed from right to left (reverse direction). However, in non-limiting exemplary embodiments of the present invention, the frequency of the horizontal synchronization signal is twice the frequency of the horizontal synchronization signal according to the image standard, so that an image signal can be outputted when a scan is performed in the reverse direction.

FIG. 4 (d) illustrates a horizontal synchronization signal generated by the horizontal synchronization signal generator 204a, and FIG. 4 (e) illustrates a vertical synchronization signal generated by the vertical synchronization signal generator 204b. Since the horizontal synchronization signal and the vertical synchronization signal are generated from the sensing signal 400 of the scanner, a starting point 401a of the sensing signal 400, a starting point 401b of the signal input to the phase locked loop, a starting point 401c of the horizontal synchronization signal, and a starting point 401d of the vertical synchronization signal can accurately coincide. By using the synchronization signal synchronized with the motion of the scanner, an image can be accurately output onto a projection plane.

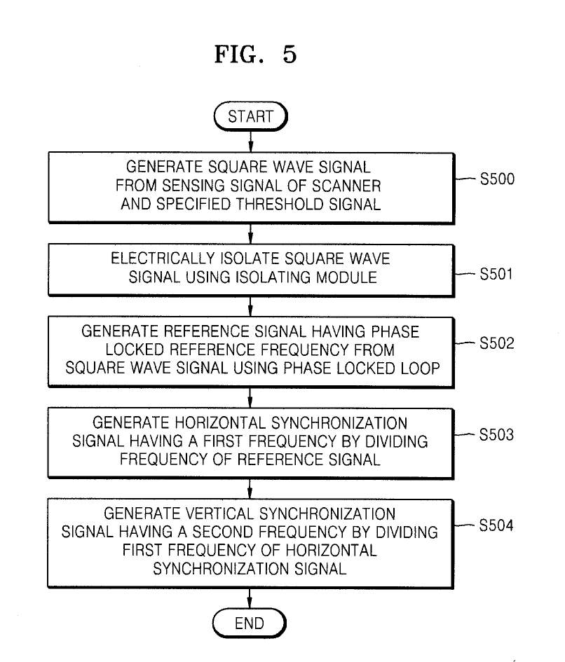

FIG. 5 is a flowchart of a method of generating a synchronization signal according to an exemplary embodiment of the present invention.

Referring to FIG. 5, an apparatus for generating a synchronization signal generates a square wave signal from a sensing signal of a scanner and a specified threshold signal in operation S500.

In operation S501, the apparatus electrically isolates the square wave signal from a previous stage using an isolating module. A device which uses light as a medium, such as a photo coupler, may be used as the isolating module.

In operation S502, the apparatus generates a reference signal, which has a phase locked reference frequency, from the square wave signal using a phase locked loop. The frequency of the reference signal is about 74.25 MHz.

Next, in operation S503, the apparatus generates a horizontal synchronization signal having a first frequency, by frequency dividing the reference frequency of the reference signal generated by the phase locked loop.

In operation S504, the apparatus generates a vertical synchronization signal having a second frequency, by frequency dividing the first frequency of the horizontal synchronization signal. Here, the first frequency is about 45 KHz and the second frequency is about 60 Hz. An accurate image output can be obtained by outputting an image signal according to the horizontal synchronization signal and the vertical synchronization signal generated by the apparatus.

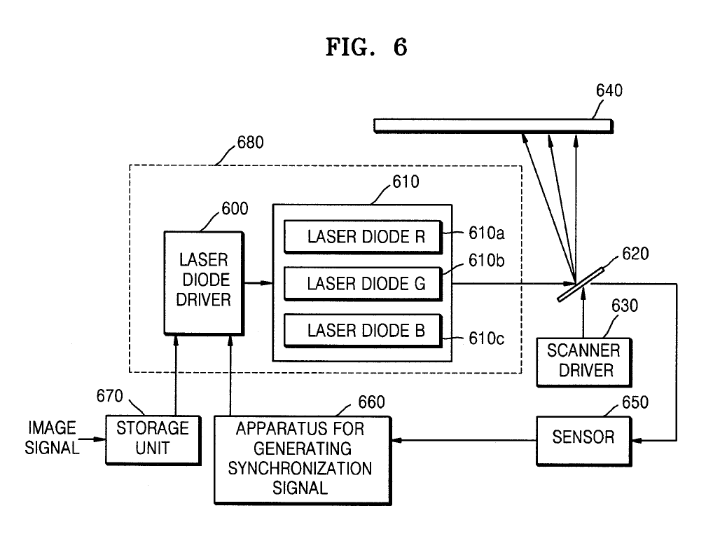

FIG. 6 is a block diagram of an image display device including an apparatus 660 for generating a synchronization signal according to an exemplary embodiment of the present invention. The image display device includes a scanner 620, a scanner driver 630, a sensor 650, the apparatus 660, a storage unit 670, and a light emitter 680. The light emitter 680 includes a laser diode driver 600, a laser diode R 610a which emits red light, a laser diode G 610b which emits green light, and a laser diode B 619c which emits blue light.

Referring to FIG. 6, the scanner driver 630 generates a driving signal for driving the scanner 620 and transmits the driving signal to the scanner 620.

The scanner 620 operates according to the driving signal received from the scanner driver 630, and displays an image on a projection plane 640 by reflecting light emitted from the light emitter 680.

The sensor 650 generates a sensing signal by detecting the motion of the scanner 620 and transmits the sensing signal to the apparatus 660.

The apparatus 660 generates a synchronization signal synchronized with the motion of the scanner 620 based on the sensing signal received from the sensor 650, and transmits the synchronization signal to the laser diode driver 600. Details about the apparatus 660 have been described above with reference to FIG. 2.

The storage unit 670 stores a received image signal and transmits the image signal to the laser diode driver 600.

The laser diode driver 600 generates driving signals for driving each of the laser diode R, G, and B, 610a, 610b, and 610c, based on the image signal received from the storage unit 670 and the synchronization signal received from the apparatus 660, and transmits the driving signals to the laser diode 610.

The laser diode 610 drives the laser diode R 610a, laser diode G 610b, and laser diode B 610c based on the driving signals received from the laser diode driver 600, and emits light to the scanner 620.

The exemplary embodiments of the present invention can also be realized as a computer readable recording medium which embodies computer readable instructions. The computer readable recording medium is any data storage device that can store data which can be thereafter read by a computer system. Examples of the computer readable recording medium include, but are not limited to, read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, the method and apparatus for generating a synchronization signal according to exemplary embodiments of the present invention can generate a phase locked reference frequency based on a sensing signal of a scanner using a phase locked loop, and generate a synchronization signal based on the generated reference frequency. Accordingly, a horizontal synchronization signal and a vertical synchronization signal can both be synchronized with the motion of the scanner.

Also, the synchronization signal generated by the apparatus for generating a synchronization signal is a signal synchronized with the motion of the scanner, and a received image signal can be accurately displayed vertically or horizontally on a projection plane by using the synchronization signal.

Also, by using an insolating module, for example, but not limited to, a photo coupler, in an input terminal of the apparatus for generating a synchronization signal, a previous stage and the apparatus can be electrically isolated from each other and thus noise can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of generating a synchronization signal, the method comprising:
generating a square wave signal based on a sensing signal which shows a motion of a scanner, and a specified threshold signal;
generating a reference signal having a phase locked reference frequency, based on the generated square wave signal; and
generating a synchronization signal synchronized with the motion of the scanner, based on the generated reference signal.

2. The method of claim 1, wherein the square wave signal is electrically isolated from the sensing signal.

3. The method of claim 1, wherein the generating of the synchronization signal comprises:
generating a horizontal synchronization signal having a first frequency by performing a first frequency division of the reference frequency of the generated reference signal; and
generating a vertical synchronization signal having a second frequency by performing a second frequency division of the first frequency of the generated horizontal synchronization signal.

4. A computer readable recording medium having recorded thereon a program comprising computer executable instructions for executing the method of claim 1.

5. A computer readable recording medium having recorded thereon a program comprising computer executable instructions for executing the method of claim 2.

6. A computer readable recording medium having recorded thereon a program comprising computer executable instructions for executing the method of claim 3.

7. An apparatus for generating a synchronization signal, the apparatus comprising:
a comparator which generates a square wave signal based on a sensing signal which shows a motion of a scanner, and a specified threshold signal;
a phase locked loop which generates a reference signal having a phase locked reference frequency, based on the generated square wave signal; and
a synchronization signal generator which generates a synchronization signal synchronized with the motion of the scanner, based on the generated reference signal.

8. The apparatus of claim 7, further comprising an isolating module which electrically isolates the square wave signal from the sensing signal.

9. The apparatus of claim 7, wherein the synchronization signal generator comprises:
a horizontal synchronization signal generator which generates a horizontal synchronization signal of a first frequency by performing a first frequency division of the reference frequency of the generated reference signal; and
a vertical synchronization signal generator which generates a vertical synchronization signal of a second frequency by performing a second frequency division of the first frequency of the generated horizontal synchronization signal.

10. An image display device comprising:
a scanner driver which generates a driving signal of a scanner;
a sensor which generates a sensing signal by detecting a motion of the scanner which moves according to the generated driving signal;
an apparatus for generating a synchronization signal which generates a synchronization signal synchronized with the motion of the scanner, based on the generated sensing signal;
a light emitter which emits a light based on the generated synchronization signal and a received image signal,
wherein the scanner displays an image by reflecting the emitted light.

11. The image display device of claim 10, wherein the apparatus for generating a synchronization signal comprises:
a comparator which generates a square wave signal based on a sensing signal which shows the motion of the scanner, and a specified threshold signal;
a phase locked loop which generates a reference signal having a phase locked reference frequency, based on the generated square wave signal; and
a synchronization signal generator which generates a synchronization signal synchronized with the motion of the scanner, based on the generated reference signal.

12. The image display device of claim 11, wherein the apparatus for generating a synchronization signal further comprises an isolating module which electrically isolates the square wave signal from the sensing signal.

13. The image display device of claim 11, wherein the synchronization signal generator comprises:
a horizontal synchronization signal generator which generates a horizontal synchronization signal having a first frequency by performing a first frequency division of the reference frequency of the generated reference signal; and
a vertical synchronization signal generator which generates a vertical synchronization signal of a second frequency by performing a second frequency division of the first frequency of the generated horizontal synchronization signal.

14. An apparatus for generating a synchronization signal, the apparatus comprising:
means for generating a square wave signal based on a sensing signal which shows a motion of a scanner, and a specified threshold signal;
means for generating a reference signal having a phase locked reference frequency, based on the generated square wave signal; and
means for generating a synchronization signal synchronized with the motion of the scanner, based on the generated reference signal.

15. The apparatus of claim 14, further comprising means for electrically isolating the square wave signal from the sensing signal.

16. The apparatus of claim 14, wherein the means for generating a synchronization signal comprises:
means for generating a horizontal synchronization signal of a first frequency by performing a first frequency division of the reference frequency of the generated reference signal; and
means for generating a a vertical synchronization signal of a second frequency by performing a second frequency division of the first frequency of the generated horizontal synchronization signal.
